(19) United States
(12) Patent Application Publication
(10) Pub. No.: US 2025/0267051 A1
(43) Pub. Date: Aug. 21, 2025

(54) Transmission Position Determination Method and User Equipment and Non-Transitory Readable Storage Medium

(71) Applicant: VIVO MOBILE COMMUNICATION CO.,LTD., Dongguan (CN)

(72) Inventors: Huan Wang, Dongguan (CN); Zichao Ji, Dongguan (CN)

(21) Appl. No.: 19/200,996

(22) Filed: May 7, 2025

Related U.S. Application Data
(63) Continuation of application No. PCT/CN2023/128635, filed on Oct. 31, 2023.

(30) Foreign Application Priority Data
Nov. 7, 2022 (CN) 202211387731.7

(51) Int. Cl. H04L 27/26; H04W 28/26; H04W 72/40; H04W 72/566; H04W 92/18

(52) U.S. Cl. CPC H04L 27/2605; H04W 28/26; H04W 72/40; H04W 72/566; H04W 92/18

(57) ABSTRACT

A transmission position determining method includes selecting, by a first UE, one CPE starting position from a plurality of CPE starting positions based on first information, and performing SL transmission; wherein the first information includes a CPE use scenario.

### CROSS-REFERENCE TO RELATED APPLICATIONS

This application is a Bypass Continuation Application of International Patent Application No. PCT/CN2023/128635 filed Oct. 31, 2023, and claims priority to Chinese Patent Application No. 202211387731.7 filed Nov. 7, 2022, the disclosures of which are hereby incorporated by reference in their entireties.

### BACKGROUND OF THE INVENTION

### Field of the Invention

This application pertains to the field of communications technologies, and in particular relates to a transmission position determining method, user equipment, and a non-transitory readable storage medium.

### Description of Related Art

When a plurality of user equipments (UE) select a same sidelink (SL) transmission resource, transmissions between UEs may interfere with each other, resulting in a transmission failure.

### SUMMARY OF THE INVENTION

According to a first aspect, a transmission position determining method is provided, where the method includes: selecting, by a first user equipment UE, one cyclic prefix extension CPE starting position from a plurality of CPE starting positions, and performing sidelink SL transmission.

According to a second aspect, a transmission position determining apparatus is provided, where the apparatus includes an execution module; and the execution module is configured to select one cyclic prefix extension CPE starting position from a plurality of CPE starting positions, and perform sidelink SL transmission.

According to a third aspect, a UE is provided, where the UE includes a processor and a memory, where a program or instructions that are executable on the processor are stored in the memory. When the program or the instructions are executed by the processor, the steps of the method according to the first aspect are implemented.

According to a fourth aspect, a UE is provided, including a processor and a communication interface, where the processor is configured to select one cyclic prefix extension CPE starting position from a plurality of CPE starting positions, and perform sidelink SL transmission.

According to a fifth aspect, a non-transitory readable storage medium is provided, where a program or instructions are stored in the non-transitory readable storage medium; and when the program or the instructions are executed by a processor, the steps of the method according to the first aspect are implemented.

According to a sixth aspect, a chip is provided. The chip includes a processor and a communication interface. The communication interface is coupled to the processor, and the processor is configured to run a program or instructions to implement the method according to the first aspect.

According to a seventh aspect, a computer program/program product is provided, where the computer program/program product is stored in a non-transitory storage medium, and the computer program/program product is executed by at least one processor to implement the steps of the transmission position determining method according to the first aspect.

### BRIEF DESCRIPTION OF THE DRAWINGS

FIG. 1 is a schematic architectural diagram of a communication system according to an embodiment of this application;

FIG. 2 is a schematic flowchart of a transmission position determining method according to an embodiment of this application;

FIG. 3 is a schematic structural diagram of a transmission position determining apparatus according to an embodiment of this application;

FIG. 4 is a schematic diagram of a hardware structure of a communication device according to an embodiment of this application; and

FIG. 5 is a schematic diagram of a hardware structure of UE according to an embodiment of this application.

### DESCRIPTION OF THE INVENTION

The following clearly describes the technical solutions in the embodiments of this application with reference to the accompanying drawings in the embodiments of this application. Apparently, the described embodiments are only some rather than all of the embodiments of this application. Based on the embodiments in this application, all other embodiments obtained by ordinary people in this field belong to the protection scope of this application.

The terms “first”, “second”, and the like in this specification and claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, “and/or” in the specification and claims represents at least one of connected objects, and the character “/” generally indicates that the associated objects have an “or” relationship.

It should be noted that technologies described in the embodiments of this application are not limited to a long term evolution (LTE) or LTE-Advanced (LTE-A) system, and may also be applied to other wireless communication systems, for example, code division multiple access (CDMA), time division multiple access (TDMA), frequency division multiple access (FDMA), orthogonal frequency division multiple access (OFDMA), single-carrier frequency-division multiple access (SC-FDMA), and other systems. The terms “system” and “network” in the embodiments of this application are often used interchangeably, and the technology described herein may be used in the above-mentioned systems and radio technologies as well as other systems and radio technologies. In the following descriptions, a new radio (NR) system is described for an illustration purpose, and NR terms are used in most of the following descriptions, although these technologies may also be applied to other applications than an NR system application, for example, the 6th generation (6G) communication system.

FIG. 1 is a block diagram of a wireless communication system to which the embodiments of this application are applicable. The wireless communication system includes a terminal 11 and a network-side device 12. The terminal 11 may be a terminal-side device such as a mobile phone, a tablet computer (Tablet Personal Computer), a laptop computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home device (a home device with wireless communication function, such as a refrigerator, a television, a washing machine, or a furniture), a game console, a personal computer (PC), a teller machine, a self-service machine, or the like. The wearable device includes: a smart watch, a wrist band, smart earphones, smart glasses, smart jewelry (smart bracelet, smart wristband, smart ring, smart necklace, smart anklet, smart ankle bracelet, or the like), smart wristband, smart clothing, and the like. It should be noted that a type of the terminal 11 is not limited in the embodiments of this application. The network-side device 12 may include an access network device or a core network device, where the access network device may also be referred to as a radio access network device, a radio access network (RAN), a radio access network function, or a radio access network unit. The access network device may include a base station, a WLAN access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission and reception point (TRP), or another appropriate term in the art. Provided that a same technical effect is achieved, the base station is not limited to a specific technical term. It should be noted that in the embodiments of this application, the base station in the NR system is merely used as an example, and a type of the base station is not limited.

The following describes technical terms involved in the technical solutions provided in the embodiments of this application by using examples.
(1) SL Resource Allocation Mode

Generally, new radio (NR) SL resources are allocated in two modes: base station scheduling mode (mode 1), and UE autonomous resource selection mode (mode 2). In the scheduled-by-base-station resource allocation mode, a base station determines a sidelink resource to be used by UE for data transmission and notifies downlink UE of the sidelink resource by using downlink signaling. In the UE autonomous selection resource allocation mode, the UE selects an available transmission resource from a (pre) configured resource pool, and the UE performs channel monitoring before resource selection, selects a resource set with less interference based on a channel monitoring result, and then randomly selects, from the resource set, a resource for transmission.

In mode 2, a operating manner is as follows:
1) After the downlink UE triggers resource selection, the physical (PHY) layer determines a resource selection window first. The lower boundary of the resource selection window is time T1 after triggering of resource selection, and the upper boundary of the resource selection window is time T2 after triggering of resource selection, where T1 is selected within a range of [T1_min, T1_max] through UE implementation; and T2 is a value selected within a packet delay budget (PDB) for TB transmission through UE implementation, where T2 is not earlier than T1.
2) Before the UE performs resource selection, the PHY layer needs to determine a candidate resource set for resource selection, in which the number of sub-channels of the candidate resources is determined by the medium access control (MAC) layer. The UE compares a reference signal received power (RSRP) estimated (for example, being estimated by monitoring the physical sidelink control channel (PSCCH)/physical sidelink shared channel (PSSCH) on resources within a resource selection window with a corresponding RSRP threshold. If the RSRP of the current transmission resource is higher than the RSRP threshold, the resource is excluded and cannot be included in the candidate resource set. Remaining resources in the resource selection window after the resource exclusion is performed form the candidate resource set. The resources in the candidate resource set account for no less than x % of the resources in the resource selection window. If less than x %, the RSRP threshold needs to be increased based on a step value (3 dB), and then the resource exclusion operation is performed until no less than x % of the resources can be selected. In addition, the RSRP comparison described above is related to priorities of TBs to be transmitted and a priority value demodulated on the PSCCH, and the process is not repeated here.
3) After the candidate resource set is determined, the PHY layer reports the candidate resource set to the MAC layer, and the MAC layer randomly selects a transmission resource from the candidate set, where the number of selected resources is determined according to the decision of the MAC layer.
(2) Sidelink Related Technologies in Unlicensed Spectrum

For SL-U (sidelink in unlicensed spectrum), a channel needs to be obtained through listen before talk (LBT) before sending of SL data. The following provides a brief description of the LBT technology:

In a further future communication system, a shared spectrum such as an unlicensed band may be used to supplement a licensed band, to help an operator expand services. In order to be consistent with NR deployment and maximize NR-based unlicensed access, the unlicensed bands may be configured in bands of 5 GHZ, 37 GHZ, and 60 GHz. Since unlicensed bands are shared by a plurality of technologies (RATs), such as Wi-Fi, radar, and LTE-LAA, in some countries or regions, usage of the unlicensed bands must comply with regulations, for example, rules such as LBT and maximum channel occupancy time (MCOT), to ensure that all devices may use the resource fairly. When needing to send information, a transmission node needs to perform LBT first for energy detection (ED) on surrounding nodes. When a detected power is lower than a threshold, a channel is considered to be idle and the transmission node can perform sending. Otherwise, the channel is considered to be busy and the transmission node cannot send data. The transmission node may be a base station, UE, a Wi-Fi AP, and the like. After the transmission node starts to perform transmission, a channel occupancy time (COT) cannot be greater than the MCOT. In addition, according to the occupied channel bandwidth (OCB) regulation, on the unlicensed band, the transmission node needs to occupy at least 70% (60 GHz) or 80% (5 GHZ) of a bandwidth of an entire band for each transmission.

The type of LBT commonly used in NRU can be divided into Type 1, Type 2A, Type 2B, and Type 2C. Type 1 LBT is a channel listening mechanism based on back-off. When the transmission node detects that a channel is busy, back-off is performed and listening continues until it is detected that the channel is idle. Type 2C means that a sending node does not perform LBT, that is, no LBT or immediate transmission. Type 2A and Type 2B LBTs are one-shot LBT, that is, the node performs LBT once before transmission, and performs transmission if the channel is idle, and performs no transmission if the channel is busy. A difference is that: Type 2A allows LBT within 25 us, which is applicable to sharing of COT, and a gap between two transmissions is greater than or equal to 25 us. Type 2B allows LBT within 16 us, which is applicable to sharing of COT, and the gap between two transmissions is equal to 16 us. In addition, there is Type 2 LBT, which is applicable to LAA/eLAA/FeLAA. For sharing of COT, when the gap between two transmissions is greater than or equal to 25 us, an eNB and UE can use Type 2 LBT. In addition, in frequency range 2-2, the types of LBT are Type 1, Type 2, and Type 3. Type 1 is a channel listening mechanism based on back-off, Type 2 is one-shot LBT and allows performing 5 us LBT within 8 us, and Type 3 allows no LBT.
(3) NR SL Resource Pre-Emption

In resource selection mode 2, a resource pre-emption mechanism is supported. A brief description of the mechanism is as follows: In a case that resources reserved by UE overlap (or partially overlap) with resources reserved or selected by another UE with a higher priority service, if a measured SL-RSRP value of the UE on related resources is greater than an associated SL-RSRP threshold, the port physical layer (PHY) of the UE triggers a preemption report to the MAC layer, to trigger resource reselection.

In order to determine whether a reserved resource is preempted, the UE performs preemption monitoring at least at a time point ‘m-T3’, where the time point ‘m’ is a time point at which the resource is located or a time point at which reservation information of the resource is transmitted, and T3 includes at least a processing duration for resource selection of the UE. The UE performs the step of resource selection again at least at ‘m-T3’ to obtain a candidate resource set. In a case that the resources selected by the UE are in the candidate resource set, the UE does not need to perform resource reselection; otherwise, the UE selects a new transmission resource from the candidate set.
(4) Application of Variable-Length CPEs

The CPE is a padding signal added before SL transmission resources. There are a plurality of CPE lengths, allowing the UE to select one CPE length during SL transmission, or select none CPE (the CPE length may be selected randomly or selected based on an SL transmission priority, where a higher priority indicates a longer CPE length). Then, if different CPE lengths are selected between two UEs with overlapping resources, starting positions of SL transmission of the two UEs are different, thereby avoiding collision.

This scheme works well in a case that only time-division multiplexing (TDM) resource multiplexing is allowed between UEs in the resource pool. However, in a case that frequency-division multiplexing (FDM) is allowed between UEs in the resource pool, if two UEs in FDM use different CPE lengths, blocking between UEs may occur. To resolve this problem, a solution was discussed at the relevant meeting: only when the UE uses all resources in a resource block (RB) set for transmission, the UE may select one starting position from a plurality of CPE starting positions for SL transmission; otherwise, a fixed starting position (for example, one in the plurality of CPE starting positions or an SL starting position in a case of no CPE) to ensure that starting positions of transmission between two UEs in FDM are consistent.

Generally, when a plurality of UEs select a same SL transmission resource, transmissions of the UEs interfere with each other, resulting in a transmission failure. Therefore, a plurality of CPE starting positions are set for SL transmission resources, and each UE may select one CPE starting position for SL transmission resources to transmit SL resources based on the CPE starting position. For example, when two UEs select different CPE starting positions, transmission of SL resources with a later CPE starting position can be cancelled based on the CPE starting positions, and only SL resources with an earlier CPE starting position can be transmitted, avoiding mutual collision between the UEs. However, when the CPE starting position is used to resolve the problem of collision between UEs, impact on UE transmission performance is not considered. Therefore, when the UE selects a CPE starting position to transmit SL resources, reliability is relatively low.

In a transmission position determining method provided in the embodiments of this application, first user equipment UE can select one CPE starting position from a plurality of CPE starting positions to perform sidelink SL transmission. In this solution, the first UE can select, before SL transmission, one appropriate CPE starting position from a plurality of CPE starting positions, to implement SL transmission; therefore, reliability in transmitting SL resources is improved.

For example, the technical solution provided in the embodiments of the application can be applied to a transmission resource position determining scenario or other scenarios.

The following describes in detail the transmission position determining method provided in the embodiments of this application by using some embodiments and application scenarios thereof with reference to the accompanying drawings.

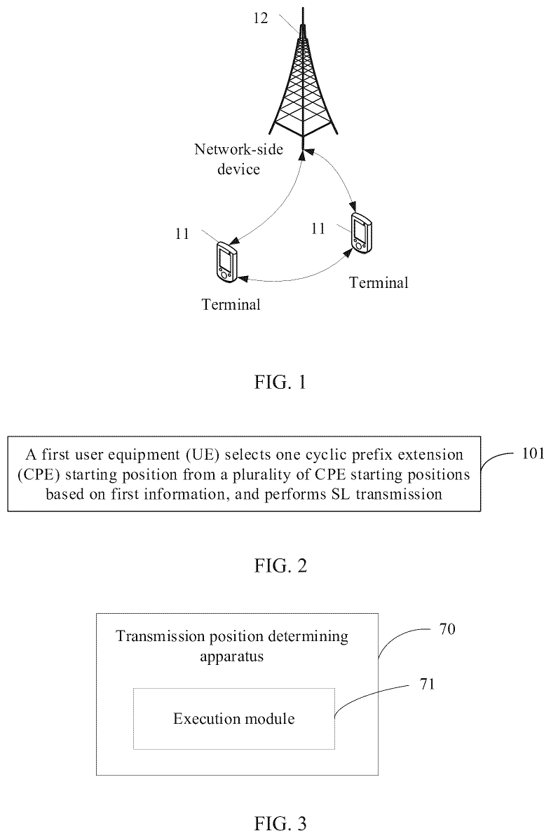

FIG. 2 illustrates a schematic flowchart of a transmission position determining method provided in an embodiment of this application. As shown in FIG. 2, the transmission position determining method may include the following step 101.

Step 101: First UE selects one CPE starting position from a plurality of CPE starting positions and performs SL transmission.

Optionally, in this embodiment of this application, step 101 may be implemented by performing the following step 201.

Step 201: The first UE selects one CPE starting position from the plurality of CPE starting positions based on first information, and performs sidelink SL transmission.

In this embodiment of this application, the first information includes at least one of the following: a transmission priority of the first UE, a remaining PDB duration associated with a transmission resource of the first UE, the number of LBT failures for the first UE, an LBT duration for the first UE, a contention window size (CWS) for LBT by the first UE, or a CPE use scenario.

Optionally, in this embodiment of this application, the selecting one CPE starting position from a plurality of CPE starting positions includes three cases:

Case 1: one CPE starting position is selected from the plurality of CPE starting positions.

Case 2: one CPE starting position is selected from a plurality of CPE starting positions and a non-CPE starting position.

Case 3: one CPE starting position is selected from one CPE starting position and a non-CPE starting position.

Optionally, in this embodiment of this application, the first information includes the transmission priority of the first UE. The foregoing step 201 can be implemented by performing the following steps 201a and 201b.

Step 201a: The first UE determines a first transmission priority group based on the transmission priority of the first UE.

In this embodiment, the first transmission priority group is a transmission priority group to which the transmission priority of the first UE belongs.

Optionally, in this embodiment of this application, a plurality of transmission priorities belonging to a certain transmission priority range can form a transmission priority group, and a plurality of CPEs belonging to a certain CPE length range can form a CPE starting position group, so as to obtain a plurality of transmission priority groups and a plurality of CPE starting position groups.

Optionally, in this embodiment of this application, a mapping relationship between the transmission priority group and the CPE starting position group can be specified, for example, a transmission priority group with a higher average priority corresponds to a CPE starting position group with a longer average length.

Step 201b: The first UE selects one CPE starting position from a first CPE starting position group corresponding to the first transmission priority group, and performs SL transmission.

Optionally, in this embodiment of this application, the first UE may determine, based on the transmission priority of the first UE, a first transmission priority group corresponding to the transmission priority of the first UE (namely, the first transmission priority group), and then determine a first CPE starting position group corresponding to the first transmission priority group based on the mapping relationship, so as to randomly select one CPE starting position from the first CPE starting position group and perform SL transmission.

In this way, it can be ensured that transmission of overlapping resources with a same priority still has the opportunity to avoid collision by selecting the CPE starting position.

Optionally, in this embodiment of this application, a mapping relationship between a remaining PDB length range and a CPE starting position can be specified, for example, a shorter remaining PDB duration indicates a longer corresponding CPE or an earlier CPE starting position.

For example, the first UE may select, based on a remaining PDB duration associated with the transmission resource of the first UE, one CPE starting position corresponding to the remaining PDB duration associated with the transmission resource of the first UE from a plurality of CPE starting positions, and perform SL transmission.

In this way, the reliability of low-delay data transmission is guaranteed.

Optionally, in this embodiment of this application, a mapping relationship between the number of LBT failures for the UE and the CPE starting position can be specified. For example, a greater number of LBT failures by the UE indicates a longer corresponding CPE.

For example, the first UE may select, based on the number of LBT failures for the first UE, one CPE starting position corresponding to the number of LBT failures for the first UE from a plurality of CPE starting positions, and perform SL transmission.

Optionally, in this embodiment of this application, a mapping relationship between an LBT duration of the UE and the CPE starting position can be specified, for example, a longer LBT duration by the UE indicates a shorter corresponding CPE.

For example, the first UE may select one CPE starting position corresponding to the LBT duration of the first UE from a plurality of CPE starting positions based on the LBT duration of the first UE, and perform SL transmission.

Optionally, in this embodiment of this application, a mapping relationship between an LBT CWS of the UE and the CPE starting position can be specified, for example, a larger LBT CWS by the UE indicates a shorter corresponding CPE.

For example, the first UE may select one CPE starting position corresponding to the LBT CWS of the first UE from a plurality of CPE starting positions based on the LBT CWS of the first UE, and perform SL transmission.

In this way, it is avoided that a specific UE cannot always access a channel, leading to lack of fairness.

Optionally, in this embodiment of this application, the first information includes a CPE use scenario. The foregoing step 201 can be implemented by performing the following step 201c.

Step 201c: The First UE selects a preset CPE starting position from a plurality of CPE

starting positions and performs SL transmission.

It can be understood that during resource transmission, the first UE may select a preset CPE starting position from a plurality of CPE starting positions and perform SL transmission; otherwise, other rules are used.

Optionally, in this embodiment of this application, the foregoing step 201c can be implemented by performing the following step 201c.

Step 201c: In a case that the first UE shares a COT with the second UE, the first UE selects the preset CPE starting position from the plurality of CPE starting positions and performs SL transmission.

In this embodiment of this application, the second UE is UE having an overlapping SL transmission resource with the first UE.

Optionally, in this embodiment of this application, when the first UE wants to use a COT shared with the second UE, the first UE may use the preset CPE starting position for SL transmission before the transmission (of the 1st shared COT).

In this way, the channel access probability is improved.

Optionally, in this embodiment of this application, if a gap between SL transmissions of the first UE and the UE sharing the COT can be less than a preset time (for example, 16 us) after selection of a preset-length CPE, the first UE may use the preset-length CPE to perform SL transmission; otherwise, other rules are used.

Optionally, in this embodiment of this application, the foregoing step 201c can be implemented by performing the following step 201c2.

Step 201c2: In a case that the first UE performs continuous transmission, the first UE selects the preset CPE starting position from the plurality of CPE starting positions and performs SL transmission.

Optionally, in this embodiment of this application, when using a CPE to fill a gap between resources, the first UE may select the preset CPE starting position; otherwise, other rules are used.

Optionally, in this embodiment of this application, the preset CPE starting position may be specified in the protocol or configured or preconfigured.

For example, the protocol specifies using the longest CPE or a CPE with a highest transmission position.

Optionally, in this embodiment of this application, the protocol may specify that a CPE can fill a gap until a distance from a previous resource is less than a preset time (16 us/25 us), and so on.

In this way, the first UE can implement continuous transmission, thereby improving the channel access probability.

Optionally, in this embodiment of this application, the foregoing step 201 can be implemented by performing the following step 201d.

Step 201d: In a case that a first condition is met, the first UE selects one CPE starting position from the plurality of CPE starting positions based on the first information, and performs SL transmission.

Optionally, in this embodiment of the application, the first condition can be understood as that the resource set corresponding to the first UE allows FDM between a plurality of UEs.

Optionally, in this embodiment of this application, the transmission position determining method provided in this embodiment of this application may further include the following step 301.

Step 301: in a case that a first condition is met, the first UE randomly selects one CPE starting position from a plurality of CPE starting positions and performs SL transmission.

It can be understood that when FDM is allowed between UEs in the resource set

corresponding to the first UE, the first UE can randomly select one CPE starting position to perform SL transmission.

In this way, it is possible for the first UE to select a fixed CPE starting position, which ensures that transmissions with different priorities all have opportunities.

Optionally, in this embodiment of this application, the first condition includes any one of the following:

A. On SL transmission resources, reserved resources of the second UE all overlap with transmission resources of the first UE.

Optionally, in this embodiment of this application, the second UE is UE having an overlapping SL transmission resource with the first UE.

Optionally, in this embodiment of this application, a moment of determining the first condition is: N time units before the first UE performs SL transmission, where N is a positive integer.

Optionally, in this embodiment of this application, when the resource set corresponding to the first UE allows FDM between a plurality of UEs on the SL transmission time domain resources, and reserved resources of the second UE all overlap with the transmission resources of the first UE (that is, the SL transmission has no FDM transmission), the first UE may select one CPE starting position from a plurality of CPE starting positions based on the first information, and performs SL transmission. Otherwise, the fixed CPE starting position is used.

Optionally, in this embodiment of this application, the overlapping resource part needs to be greater than a preset number.

Optionally, in this embodiment of this application, the first UE may determine, based on SCI associated with a demodulated transmission resource of the second UE, that “on the SL transmission resources, the reserved resources of the second UE all overlap with the transmission resources of the first UE.”

B. On the SL transmission resources, the reserved resources of the second UE are not detected.

Optionally, in this embodiment of this application, when the resource set corresponding to the first UE allows FDM between a plurality of UEs on the SL transmission time domain resources, and the reserved resources of the second UE are not detected on the SL transmission time domain resources, the first UE may select, based on the first information, one CPE starting position from a plurality of CPE starting positions for SL transmission. Otherwise, a fixed starting position is used.

Optionally, in this embodiment of this application, when determining whether there is a reserved resource of the second UE on the SL transmission resources, the first UE can perform determining based on SCI associated with a demodulated transmission resource of the second

C. Second information associated with the SL transmission resources meets a second condition.

The second information includes at least one of the following: a transmission priority of the first UE, a remaining PDB duration associated with the transmission resources of the first UE, or a propagation form associated with the transmission resources of the first UE.

Optionally, in this embodiment of this application, the second condition includes any one of the following:

Condition A: On SL transmission time domain resources, the transmission priority of the first UE is higher than or not lower than a first threshold.

It can be understood that when the transmission priority of the first UE is higher than or not lower than the first threshold on the SL transmission time domain resources, the first UE may select one CPE starting position from a plurality of CPE starting positions based on the first information, and performs SL transmission. Otherwise, a fixed starting position is used.

Optionally, in this embodiment of this application, the first threshold may be specified by the protocol, configured, or preconfigured.

Condition B: On the SL transmission time domain resources, the remaining PDB duration associated with the transmission resources of the first UE is less than or equal to a second threshold.

It can be understood that when the remaining PDB duration associated with the transmission resources of the first UE is less than or equal to a second threshold on the SL transmission time domain resources, the first UE may select one CPE starting position from a plurality of CPE starting positions based on the first information, and performs SL transmission. Otherwise, a fixed starting position is used.

Optionally, in this embodiment of this application, the second threshold may be specified by the protocol, configured, or preconfigured.

Condition C: On the SL transmission time domain resources, the propagation form associated with the transmission resources of the first UE is a preset propagation form or a unicast propagation form.

It can be understood that when the propagation form associated with the transmission resources of the first UE is a preset propagation form or a unicast propagation form on the SL transmission time domain resources, the first UE may select one CPE starting position from a plurality of CPE starting positions based on the first information, and performs SL transmission. Otherwise, a fixed starting position is used.

In this way, only an SL transmission with a higher transmission priority or a specific SL transmission is allowed, which improves the reliability of transmission.

D: On the transmission resources, a transmission priority associated with a first reserved resource is lower than or not higher than a transmission priority of the first UE.

Optionally, in this embodiment of this application, the first reserved resource is a resource whose CPE starting position is later than the CPE starting position of the first UE in the reserved resources of the second UE.

Optionally, in this embodiment of this application, a CPE starting position of the reserved resource of the second UE is determined by the first UE by demodulating the reserved resource of the second UE, or is determined by the first UE by demodulating sidelink control information SCI associated with the reserved resource of the second UE.

Optionally, in this embodiment of this application, when the transmission priority of the first UE is higher than or not lower than the transmission priority associated with the first reserved resource on the SL transmission time domain resources, the first UE may select one CPE starting position from a plurality of CPE starting positions based on the first information, and performs SL transmission. Otherwise, a fixed starting position is used.

Optionally, in this embodiment of this application, when determining whether the transmission priority associated with the first reserved resource is lower than or not higher than the transmission priority of the first UE on the SL transmission resources, the first UE may perform determining based on SCI associated with a demodulated transmission resource of the second UE.

Optionally, in this embodiment of this application, the foregoing step 201 can be implemented by performing the following step 201e.

Step 201e: In a case that the resource set (RB set or resource block set) corresponding to the first UE allows selection of the CPE starting position, the first UE selects one CPE starting position from a plurality of CPE starting positions based on the first information, and performs SL transmission.

Optionally, in this embodiment of this application, the resource set corresponding to the first UE can be configured, preconfigured or indicated to whether to allow the first UE to select one CPE starting position from a plurality of CPE starting positions for SL transmission. In a case that selection of a CPE starting position is allowed for a resource set corresponding to the first UE, the first UE selects one CPE starting position from the plurality of CPE starting positions based on first information, and performs SL transmission.

In this way, the transmission efficiency on different resource sets can be controlled.

For example, the resource set corresponding to the first UE can be configured or preconfigured or indicated to whether the UE is required to perform TDM transmission on the resource set, or the transmission needs to occupy the resources in the resource set, or the transmission needs to occupy a specific proportion of the resources in the resource set.

For example, the resource set can merely allow the UE to perform TDM transmission, and the first UE may select one CPE starting position from a plurality of CPE starting positions for SL transmission; or, the resource set is not limited, and the first UE chooses, based on its own transmission statuses (for example, a frequency domain resource size), to transmit on an appropriate resource set.

Optionally, in this embodiment of this application, step 201 may be implemented by performing the following step 201f.

Step 201f: In a case that a transmission resource of the first UE meets a resource

pre-emption condition and a reserved resource of second UE meets a third condition, the first UE does not trigger resource reselection, selects one CPE starting position from a plurality of CPE starting positions, and performs SL transmission.

In this embodiment of this application, the second UE is UE having an overlapping SL transmission resource with the first UE.

Optionally, in the embodiment of this application, the third condition includes at least one of the following:

that a CPE starting position associated with the reserved resource of the second UE is before a CPE starting position of the first UE; or
that a total transmission energy associated with the reserved resource of the second UE is greater than or equal to a third threshold.

Optionally, in this embodiment of this application, a selected resource of the first UE meeting a resource pre-emption report may include at least one of the following: an RSRP measurement value associated with the reserved resources of the second UE overlapping the transmission resources of the first UE is higher than an RSRP threshold; a transmission priority associated with the reserved resources of the second UE is higher than the transmission priority of the first UE; or the transmission priority associated with the reserved resources of the second UE is higher than a preset transmission priority threshold.

Optionally, in this embodiment of this application, the first UE can determine, according to an implicit rule, whether the CPE starting positions associated with the reserved resources of the second UE are all before the CPE starting positions of the first UE.

For example, if the transmission priority associated with the reserved resources of the second UE is higher than that of the first UE, the CPE starting positions associated with the reserved resources of the second UE are all before the CPE starting positions of the first UE.

Optionally, in this embodiment of this application, the preset energy value may be an energy detection threshold (EDT).

Optionally, in this embodiment of this application, the one CPE starting position is a CPE starting position corresponding to the 1st automatic gain control AGC position in one time unit, or a CPE starting position corresponding to an AGC position other than the 1st AGC position in one time unit.

Optionally, in this embodiment of this application, the one CPE starting position or a length of the one CPE is independently configured or independently indicated.

Optionally, in this embodiment of this application, the first UE may perform transmission using the 1st AGC position in a slot as the CPE starting position, and performs transmission using the 2nd/n-th AGC position in the slot as the CPE starting position.

Optionally, in this embodiment of this application, for transmission using the 1st AGC position in the slot as a starting position of PSCCH/PSSCH, a length of CPE may be x1, x2, x3, . . . , and so on; and for transmission using the 1st AGC position in the slot as the starting position of PSCCH/PSSCH, the length of CPE may be x1+L, x2+L, x3+1, . . . , and so on.

In this way, the transmission using the 1st AGC position in the slot as the CPE starting position can access the channel at an earlier time. Alternatively, in this embodiment of this application, a length of L may be variable, for example, any value in the number of symbols from an end position of the 1st AGC to a start position of the 2nd AGC.

Optionally, in this embodiment of this application, for transmission using the 1st AGC position in the slot as a starting position of PSCCH/PSSCH, a length of CPE may be x1, x2, x3, . . . , and so on; and for transmission using the 1st AGC position in the slot as the starting position of PSCCH/PSSCH, the length of CPE may be x1*K, x2*K, x3*K, . . . , and so on.

Optionally, in this embodiment of this application, the step of “performing SL transmission” in the foregoing step 201 can be implemented by performing the following step 201g.

Step 201g: The first UE starts to perform LBT from one CPE starting position, and performs SL transmission in a case that LBT is successful.

Optionally, in this embodiment of this application, after the first UE selects one CPE starting position, the first UE can attempt to access from a selected CPE starting position and a later CPE starting position, and provided that the LBT is successful, the first UE can perform SL transmission.

In a transmission position determining method provided in the embodiments of this application, first user equipment UE can select one CPE starting position from a plurality of CPE starting positions to perform sidelink SL transmission. In this solution, the first UE can select, before SL transmission, one appropriate CPE starting position from a plurality of CPE starting positions, to implement SL transmission; therefore, reliability in transmitting SL resources is improved.

For the transmission position determining method provided in this embodiment of this application, the execution subject may be a transmission position determining apparatus. The transmission position determining apparatus provided in an embodiment of this application is described by assuming that the transmission position determining apparatus performs the transmission position determining method in the embodiments of this application.

FIG. 3 is a possible schematic structural diagram of a transmission position determining apparatus involved in the embodiments of this application, and the transmission position determining apparatus is applied to first UE. As shown in FIG. 3, the transmission position determining apparatus 70 may include an execution module 71.

The execution module 71 is configured to select one CPE starting position from a plurality of CPE starting positions, and perform sidelink SL transmission.

This embodiment of the application provides a transmission position determining apparatus. The transmission position determining apparatus can select, before SL transmission, one appropriate CPE starting position from a plurality of CPE starting positions, to implement SL transmission; therefore, reliability in transmitting SL resources is improved.

In a possible implementation, the execution module 71 is configured to select one CPE starting position from the plurality of CPE starting positions based on first information, and perform SL transmission; where
the first information includes at least one of the following: a transmission priority of the first UE, a remaining packet delay budget PDB duration associated with a transmission resource of the first UE, the number of LBT failures for the first UE, an LBT duration for the first UE, a contention window size CWS for LBT by the first UE, or a CPE use scenario.

In a possible implementation, the first information includes a transmission priority of the first UE; and the execution module 71 is configured to determine a first transmission priority group based on the transmission priority of the first UE, where the first transmission priority group is a transmission priority group to which the transmission priority of the first UE belongs;

select one CPE starting position from a first CPE starting position group corresponding to the first transmission priority group; and perform SL transmission.

In a possible implementation, the first information includes a length of each CPE in a plurality of CPEs; and the execution module 71 is configured to select the preset CPE starting position from the plurality of CPE starting positions and perform SL transmission.

In a possible implementation, the execution module 71 is configured to: in a case that the first UE shares a channel occupancy time COT with second UE, select the preset CPE starting position from the plurality of CPE starting positions and perform SL transmission.

In a possible implementation, the execution module 71 is configured to: in a case that the first UE performs continuous transmission, select the preset CPE starting position from the plurality of CPE starting positions and perform SL transmission.

In a possible implementation, the execution module 71 is configured to: in a case that a first condition is met, select one CPE starting position from the plurality of CPE starting positions based on first information, and perform SL transmission.

In a possible implementation, the execution module 71 is further configured to: in a case that the first condition is met, randomly select one CPE starting position from the plurality of CPE starting positions and perform SL transmission.

In a possible implementation, the first condition includes any one of the following: on SL transmission resources, reserved resources of second UE all overlap with transmission resources of the first UE, where the second UE is UE performing SL transmission time domain resource multiplexing with the first UE; on the SL transmission resources, the reserved resources of the second UE are not detected; second information associated with the SL transmission resources meets a second condition; and on the SL transmission resources, a transmission priority associated with a first reserved resource is lower than or not higher than a transmission priority of the first UE, where the first reserved resource is a resource whose CPE starting position is later than the CPE starting position of the first UE in the reserved resources of the second UE; where the second information includes at least one of the following: a transmission priority of the first UE, a remaining PDB duration associated with the transmission resources of the first UE, or a propagation form associated with the transmission resources of the first UE.

In a possible implementation, the second condition includes any one of the following: on SL transmission time domain resources, the transmission priority of the first UE is higher than or not lower than a first threshold; on the SL transmission time domain resources, the remaining PDB duration associated with the transmission resources of the first UE is less than or equal to a second threshold; and on the SL transmission time domain resources, the propagation form associated with the transmission resources of the first UE is a preset propagation form or a unicast propagation form.

In a possible implementation, a moment of determining the first condition is: N time units before the first UE performs SL transmission, where N is a positive integer.

In a possible implementation, the execution module 71 is configured to: in a case that selection of a CPE starting position is allowed for a resource set corresponding to the first UE, select one CPE starting position from the plurality of CPE starting positions based on first information, and perform SL transmission.

In a possible implementation, the execution module 71 is configured to: in a case that a transmission resource of the first UE meets a resource pre-emption condition and a reserved resource of second UE meets a third condition, not trigger resource reselection, select one CPE starting position from a plurality of CPE starting positions, and perform SL transmission; where the third condition includes at least one of the following: that a CPE starting position associated with the reserved resource of the second UE is before a CPE starting position of the first UE, where the second UE is UE having an overlapping SL transmission resource with the first UE; or that a total transmission energy associated with the reserved resource of the second UE is greater than or equal to a third threshold.

In a possible implementation, the one CPE starting position is a CPE starting position corresponding to the 1st automatic gain control AGC position in one time unit, or a CPE starting position corresponding to an AGC position other than the 1st AGC position in one time unit; and the one CPE starting position or a length of the one CPE is independently configured or independently indicated.

The transmission position determining apparatus provided in this embodiment of this application can implement the processes implemented by the first UE in the foregoing method embodiment, with the same technical effects achieved. To avoid repetition, details are not described herein again.

The transmission position determining apparatus in this embodiment of this application may be UE, such as UE with an operating system, or a component in the UE, such as an integrated circuit or a chip. The UE may be a terminal or other devices than the terminal. For example, the UE may include, but is not limited to, the types of the UE 11 listed above, and other devices may be a server, a network attached storage (NAS), and the like. This is not limited in the embodiments of this application.

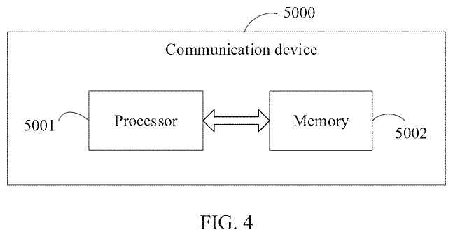

Optionally, as shown in FIG. 4, an embodiment of this application further provides a communication device 5000, including a processor 5001 and a memory 5002. A program or instructions that are executable on the processor 5001 are stored in the memory 5002. For example, when the communication device 5000 is UE and when the program or the instructions are executed by the processor 5001, the steps of the foregoing embodiments of the method on the first UE side are implemented, with the same technical effects achieved. To avoid repetition, details are not described herein again.

An embodiment of this application further provides UE, which includes a processor and a communication interface, where the processor is configured to select one CPE starting position from a plurality of CPE starting positions based on first information, and perform sidelink SL transmission, where the first information includes at least one of the following: a transmission priority of the first UE, a remaining PDB duration associated with a transmission resource of the first UE, the number of LBT failures for the first UE, an LBT duration for the first UE, a CWS size for LBT by the first UE, or a length of each CPE in a plurality of CPEs. The first UE embodiment corresponds to the foregoing UE side method embodiment, and the implementation processes and implementations of the foregoing method embodiments can be applied to the UE embodiments, with the same technical effects achieved.

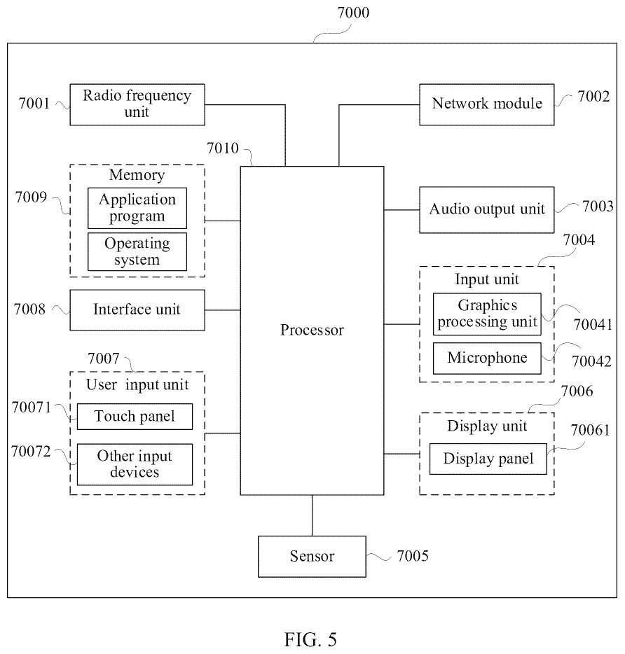

For example, FIG. 5 is a schematic diagram of a hardware structure of UE implementing an embodiment of this application.

The UE 7000 includes but is not limited to at least part of components such as a radio frequency unit 7001, a network module 7002, an audio output unit 7003, an input unit 7004, a sensor 7005, a display unit 7006, a user input unit 7007, an interface unit 7008, a memory 7009, and a processor 7010.

A person skilled in the art may understand that the UE 7000 may further include a power supply (such as a battery) for supplying power to the components. The power supply may be logically connected to the processor 7010 through a power management system. In this way, functions such as charge management, discharge management, and power consumption management are implemented by using the power management system. The structure of the UE shown in FIG. 5 does not constitute a limitation on the UE. The UE may include more or fewer components than those shown in the figure, or some components are combined, or component arrangements are different. Details are not described herein again.

It can be understood that in this embodiment of this application, the input unit 7004 may include a graphics processing unit (GPU) 70041 and a microphone 70042. The graphics processing unit 70041 processes image data of a still picture or video obtained by an image capture apparatus (such as a camera) in a video capture mode or an image capture mode. The display unit 7006 may include a display panel 70061, and the display panel 70061 may be configured in a form of a liquid crystal display, an organic light-emitting diode, and the like. The user input unit 7007 includes at least one of a touch panel 70071 or other input devices 70072. The touch panel 70071 is also referred to as a touchscreen. The touch panel 70071 may include two parts: a touch detection apparatus and a touch controller. The other input devices 70072 may include but are not limited to a physical keyboard, a function key (such as a volume control key or a power on/off key), a trackball, a mouse, a joystick, and the like. Details are not described herein.

In this embodiment of this application, after receiving downlink data from a network-side device, the radio frequency unit 7001 sends the downlink data to the processor 7010 for processing; and the radio frequency unit 7001 also sends uplink data to the network-side device. Generally, the radio frequency unit 7001 includes, but is not limited to, an antenna, an amplifier, a transceiver, a coupler, a low noise amplifier, a duplexer, and the like.

The memory 7009 may be configured to store software programs or instructions and various data. The memory 7009 may mainly include a first storage area for storing programs or instructions and a second storage area for storing data, where the first storage area may store an operating system, an application program or instructions required by at least one function (for example, an audio playing function and an image playing function), and the like. In addition, the memory 7009 may be a volatile memory or a non-volatile memory, or the memory 7009 may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), synchronous dynamic random access memory (SDRAM), a double data rate synchronous dynamic random access memory (DDRSDRAM), an enhanced synchronous dynamic random access memory (ESDRAM), a synchronous link dynamic random access memory (SLDRAM), and a direct memory bus random access memory (DRRAM). The memory 7009 described in this embodiment this application includes but is not limited to these and any other suitable types of memories.

The processor 7010 may include one or more processing units. Optionally, the processor 7010 integrates an application processor and a modem processor. The application processor mainly processes operations related to an operating system, a user interface, an application program, and the like. The modem processor mainly processes wireless communication signals, for example, a baseband processor. It should be understood that alternatively, the modem processor may not be integrated into the processor 7010.

The processor 7010 is configured to select one CPE starting position from a plurality of CPE starting positions, and perform sidelink SL transmission.

This embodiment of the application provides UE. The UE can select one appropriate CPE starting position from a plurality of CPE starting positions before SL transmission, to implement SL transmission; therefore, reliability in transmitting SL resources is improved.

The UE provided in this embodiment of this application can implement the processes implemented by the first UE in the foregoing method embodiment, with the same technical effects achieved. To avoid repetition, details are not described herein again.

An embodiment of this application further provides a non-transitory readable storage medium, where the non-transitory readable storage medium stores a program or instructions, and when the program or instructions are executed by a processor, the processes of the foregoing embodiments of the transmission position determining method are implemented, with the same technical effects achieved. To avoid repetition, details are not described herein again.

The processor is a processor in the communication device in the foregoing embodiment. The non-transitory readable storage medium includes non-transitory computer readable storage medium, such as computer read-only memory ROM, random access memory RAM, magnetic disk or optical disk, etc.

An embodiment of this application further provides a chip. The chip includes a processor and a communication interface. The communication interface is coupled to the processor. The processor is configured to run a program or instructions to implement each process of the foregoing method embodiment, with the same technical effect achieved. To avoid repetition, details are not described herein again.

It should be understood that the chip mentioned in the embodiments of this application may also be referred to as a system-level chip, a system chip, a chip system, a system-on-chip, or the like.

An embodiment of this application further provides a computer program/program product, where the computer program/program product is stored in a non-transitory storage medium, and when being executed by at least one processor, the computer program/program product is configured to implement the processes of the foregoing embodiments of the method, with the same technical effects achieved. To avoid repetition, details are not repeated herein.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. It should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

By means of the foregoing description of the implementations, persons skilled in the art may clearly understand that the method in the foregoing embodiment may be implemented by software with a necessary general hardware platform. Certainly, the method in the foregoing embodiment may also be implemented by hardware. Based on such an understanding, the technical solutions of this application essentially or the part contributing to the prior art may be implemented in a form of a software product. The software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing implementations. These implementations are merely illustrative rather than restrictive. Inspired by this application, persons of ordinary skill in the art may develop many other forms without departing from the essence of this application and the protection scope of the claims, and all such forms shall fall within the protection scope of this application.

What is claimed is:

1. A transmission position determining method, wherein the method comprises:
selecting, by a first user equipment (UE), one cyclic prefix extension (CPE) starting position from a plurality of CPE starting positions based on first information, and performing sidelink (SL) transmission; wherein the first information comprises a CPE use scenario.

2. The method according to claim 1, wherein the first information further comprises at least one of the following: a transmission priority of the first UE, a remaining packet delay budget (PDB) duration associated with a transmission resource of the first UE, the number of listen before talk (LBT) failures for the first UE, an LBT duration for the first UE, or a contention window size (CWS) for LBT by the first UE.

3. The method according to claim 1, wherein the selecting, by the first UE, one CPE starting position from the plurality of CPE starting positions based on first information, and performing SL transmission comprises:
selecting, by the first UE, a preset CPE starting position from the plurality of CPE starting positions, and performing SL transmission.

4. The method according to claim 3, wherein the selecting, by the first UE, a preset CPE starting position from the plurality of CPE starting positions, and performing SL transmission comprises:
in a case that the first UE performs continuous transmission, selecting, by the first UE, the preset CPE starting position from the plurality of CPE starting positions, and performing SL transmission.

5. The method according to claim 2, wherein the selecting, by the first UE, one CPE starting position from the plurality of CPE starting positions based on first information, and performing SL transmission comprises:
in a case that a first condition is met, selecting, by the first UE, one CPE starting position from the plurality of CPE starting positions based on the first information, and performing SL transmission.

6. The method according to claim 5, wherein the first condition comprises any one of the following:
on SL transmission resources, reserved resources of a second UE all overlap with transmission resources of the first UE, wherein the second UE is a UE having an overlapping SL transmission resource with the first UE;
on the SL transmission resources, the reserved resources of the second UE are not detected;
second information associated with the SL transmission resources meets a second condition; and
on the SL transmission resources, a transmission priority associated with a first reserved resource is lower than or not higher than the transmission priority of the first UE, wherein the first reserved resource is a resource whose CPE starting position is later than a CPE starting position of the first UE in the reserved resources of the second UE; wherein
the second information comprises at least one of the following: the transmission priority of the first UE, the remaining PDB duration associated with the transmission resources of the first UE, or a propagation form associated with the transmission resources of the first UE.

7. The method according to claim 6, wherein the second condition comprises any one of the following:
on SL transmission time domain resources, the transmission priority of the first UE is higher than or not lower than a first threshold;
on the SL transmission time domain resources, the remaining PDB duration associated with the transmission resources of the first UE is less than or equal to a second threshold; and
on the SL transmission time domain resources, the propagation form associated with the transmission resources of the first UE is a preset propagation form or a unicast propagation form.

8. The method according to claim 6, wherein a moment of determining the first condition is: N time units before the first UE performs SL transmission, wherein N is a positive integer.

9. The method according to claim 2, wherein the selecting, by the first UE, one CPE starting position from the plurality of CPE starting positions based on first information, and performing SL transmission comprises:
in a case that selection of a CPE starting position is allowed for a resource set corresponding to the first UE, selecting, by the first UE, one CPE starting position from the plurality of CPE starting positions based on the first information, and performing SL transmission.

10. The method according to claim 1, wherein the selecting, by a first UE, one CPE starting position from a plurality of CPE starting positions based on first information, and performing SL transmission comprises:
in a case that a transmission resource of the first UE meets a resource pre-emption condition and a reserved resource of a second UE meets a third condition, not triggering, by the first UE, resource reselection, selecting one CPE starting position from the plurality of CPE starting positions, and performing SL transmission; wherein
the third condition comprises at least one of the following:
that a CPE starting position associated with the reserved resource of the second UE is before a CPE starting position of the first UE, wherein the second UE is a UE having an overlapping SL transmission resource with the first UE; or
that a total transmission energy associated with the reserved resource of the second UE is greater than or equal to a third threshold.

11. The method according to claim 1, wherein the one CPE starting position is a CPE starting position corresponding to the 1st automatic gain control (AGC) position in one time unit, or a CPE starting position corresponding to an AGC position other than the 1st AGC position in one time unit; and the one CPE starting position or a length of one CPE is independently configured or independently indicated.

12. The method according to claim 1, wherein the performing SL transmission comprises:
attempting, by the first UE, to access a channel from the one CPE starting position and a CPE starting position after the one CPE starting position, and performing SL transmission in a case that LBT is successful.

13. A user equipment (UE), comprising a processor and a memory, wherein the memory stores a program or instructions that are executable on the processor, and the program or instructions, when executed by the processor, cause the UE to perform:
selecting one cyclic prefix extension (CPE) starting position from a plurality of CPE starting positions based on first information, and performing sidelink (SL) transmission; wherein the first information comprises a CPE use scenario.

14. The UE according to claim 13, wherein the first information further comprises at least one of the following: a transmission priority of the UE, a remaining packet delay budget (PDB) duration associated with a transmission resource of the UE, the number of listen before talk (LBT) failures for the UE, an LBT duration for the UE, or a contention window size (CWS) for LBT by the UE.

15. The UE according to claim 13, wherein the program or instructions, when executed by the processor, cause the UE to perform:
selecting a preset CPE starting position from the plurality of CPE starting positions, and performing SL transmission.

16. The UE according to claim 15, wherein the program or instructions, when executed by the processor, cause the UE to perform:
in a case that the UE performs continuous transmission, selecting the preset CPE starting position from the plurality of CPE starting positions, and performing SL transmission.

17. A non-transitory readable storage medium, wherein the non-transitory readable storage medium stores a program or instructions, and the program or instructions, when executed by a processor of a user equipment (UE), cause the UE to perform:
selecting one cyclic prefix extension (CPE) starting position from a plurality of CPE starting positions based on first information, and performing sidelink (SL) transmission; wherein the first information comprises a CPE use scenario.

18. The non-transitory readable storage medium according to claim 17, wherein the first information further comprises at least one of the following: a transmission priority of the UE, a remaining packet delay budget (PDB) duration associated with a transmission resource of the UE, the number of listen before talk (LBT) failures for the UE, an LBT duration for the UE, or a contention window size (CWS) for LBT by the UE.

19. The non-transitory readable storage medium according to claim 17, wherein the program or instructions, when executed by the processor, cause the UE to perform:
selecting a preset CPE starting position from the plurality of CPE starting positions, and performing SL transmission.

20. The non-transitory readable storage medium according to claim 19, wherein the program or instructions, when executed by the processor, cause the UE to perform:
in a case that the UE performs continuous transmission, selecting the preset CPE starting position from the plurality of CPE starting positions, and performing SL transmission.
